(19) United States
(12) Patent Application Publication
(10) Pub. No.: US 2006/0256986 A1
(43) Pub. Date: Nov. 16, 2006

(54) REMOTE CONTROL SYSTEM WITH A WIRELESS EARPHONE FUNCTION AND CORRESPONDING METHOD

(76) Inventors: Xiao-Guang Li, Shenzhen (CN); Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/164,330

(22) Filed: Nov. 18, 2005

(30) Foreign Application Priority Data
May 13, 2005 (CN) 200510034650.9

(51) Int. Cl. H04R 5/02

(52) U.S. Cl. 381/309

(57) ABSTRACT

A remote control method with a wireless earphone function, the method providing a host for playing video signals and audio signals and a remote control, the host including an audio playing unit, the method includes the steps of: receiving a connectivity signal from an audio signal outlet thereof, and determining whether the connectivity signal indicates that an earphone is connected with an audio signal outlet; transmitting a first volume adjusting instruction to the host if the signal indicates that an earphone is connected with an audio signal outlet; adjusting a volume of the audio playing unit according to the first volume adjusting instruction; transmitting audio signals to the remote control; receiving the audio signals; and outputting the audio signals to the earphone via the audio signal outlet. A related system is also provided.

### FIELD OF THE INVENTION

The present invention relates generally to remote control systems and methods, and particularly to a remote control system with a wireless earphone function and a related remote control method.

### DESCRIPTION OF RELATED ART

Many people have had the unpleasant experience of being disturbed in the night by the sound of a stereo or television being used by someone else. Instead of turning down or turning off the volume, an individual may use an earphone to enjoy their audio or viewing experience so as not to disturb others.

A conventional earphone includes a headset and a connecting cable having a predetermined length electrically connecting the headset with a device such as a television or a stereo. However, the conventional earphone has several drawbacks. When the earphone is electrically connected to a television or stereo, the movement of the user is limited to the length of the connecting cable. In addition, the user may be at risk of tripping over the connecting cable. Furthermore, since the user is limited by the length of the connecting cable, he or she must sit nearer the television, which may negatively affect his/her eyesight.

In order to solve the above-mentioned problems, a wireless earphone is needed so that the user is able to enjoy listening to their television, stereo, or other device wirelessly without disturbing others and while still enjoying freedom of movement as well. However, a wireless earphone may be subject to interference during movement of the user, which may affect the sound quality. Conventionally, to compensate for audio signal loss during wireless transmission, an expensive high-end circuit configuration must be employed.

Accordingly, what is needed is a remote control system with a wireless earphone function and a related method which can overcome the above-described problems and provide convenience to users.

### SUMMARY OF INVENTION

A remote control system with a wireless earphone function according to a preferred embodiment of the present invention includes a host and a remote control for controlling the host. The host includes a receiver, a second Microprogrammable Control Unit (MCU), an audio signal amplifying module, an audio playing unit for playing sounds, an audio signal output module for outputting audio signals, and an audio signal transmitter for transmitting the audio signals to the remote control. The remote control includes an earphone audio unit, a first MCU, and a transmitter. The earphone audio unit includes a receiver for receiving the audio signals from the host, an audio signal outlet for connecting with an earphone, and an earphone detection module for detecting whether an earphone is connected with the audio signal outlet. The first MCU is for generating a first volume adjusting instruction if the earphone detection module detects that the earphone is connected with the audio signal outlet. The transmitter is for transmitting a signal corresponding to the first volume adjusting instruction to the host. When the host receives the first signal, the host does not output audio signals to the audio playing unit.

A remote control method with a wireless earphone function according to another preferred embodiment of the present invention is also provided. The method utilizes a host for playing video signals and audio signals, and a remote control for controlling the host. The host includes an audio playing unit and an audio signal transmitter. The method includes the steps of: (a) the remote control receiving a connectivity signal from an audio signal outlet thereof, and determining whether the connectivity signal indicates that an earphone is connected with the audio signal outlet; (b) the remote control transmitting a first volume adjusting instruction to the host if the signal indicates that an earphone is connected with the audio signal outlet; (c) the host adjusting a volume of the audio playing unit according to the first volume adjusting instruction; (d) the host transmitting audio signals to the remote control; (e) the remote control receiving the audio signals; and (f) the remote control outputting the audio signals to the earphone via the audio signal outlet.

Because a hand held remote control is a common piece of equipment for wirelessly controlling many electronic devices, the above-described system and method provide convenient means for a user to take advantage of the availability of an earphone if desired.

Other advantages and novel features will be drawn from the following detailed description of the preferred embodiments with reference to the attached drawings, in which:

### BRIEF DESCRIPTION OF DRAWINGS

FIG. 1 is a block diagram of hardware infrastructure of a remote control of a remote control system with a wireless earphone function in accordance with a preferred embodiment of the present invention;

FIG. 2 is a block diagram of hardware infrastructure of a host of the remote control system with a wireless earphone function in accordance with a preferred embodiment of the present invention;

FIG. 3 is a flowchart of a preferred method of remote control performed by utilizing the remote control system of FIG. 1;

FIG. 4 is flowchart of implementing one step of FIG. 3, namely turning off audio signals to an audio playing unit, and outputting audio signals via an audio signal transmitter to the remote control; and

FIG. 5 is a flowchart of implementing another step of FIG. 3, namely outputting audio signals via the audio playing unit.

### DETAILED DESCRIPTION

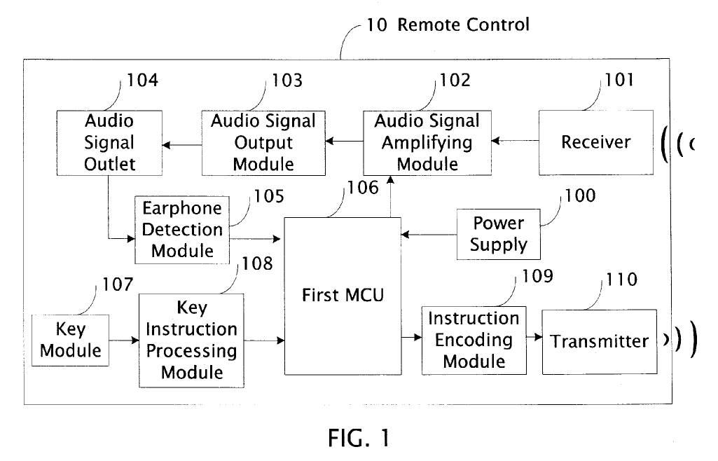

A remote control system with a wireless earphone function and method according to preferred embodiments of the present invention will be described with reference to FIGS. 1 to 5. In the preferred embodiment, the remote control system with a wireless earphone function (hereafter, “the system”) includes a remote control 10 and a host 20.

FIG. 1 is a block diagram of hardware infrastructure of the remote control 10 of the system. In the preferred embodiment, the remote control 10 includes an earphone audio unit, a power supply 100, a first Microprogrammable Control Unit (MCU) 106, and a remote control unit. The earphone audio unit includes a receiver 101, an audio signal amplifying module 102, an audio signal output module 103, an audio signal outlet 104, and an earphone detection module 105. The remote control unit includes a key module 107, a key instruction processing module 108, an instruction encoding module 109, and a transmitter 110. The receiver 101 receives an audio signal from the host 20, and transmits the audio signal to the audio signal amplifying module 102. The audio signal amplifying module 102 adjusts the audio signal, and outputs the adjusted audio signal to the audio signal outlet 104 through the audio signal output module 103. An earphone (not shown) can be plugged into an earphone jack of the audio signal outlet 104, so that the audio signal outlet 104 sends the audio signals to the earphone for playing of the corresponding sounds. The earphone detection module 105 is provided for detecting signals from the earphone jack. For example, if the earphone detection module 105 detects that the earphone is plugged into the audio signal outlet 104: the earphone detection module 105 transmits an in use signal to the first MCU 106; the first MCU 106 transmits an instruction to the instruction encoding module 109 for turning off the audio signal to the audio signal amplifying module 208 of the host 20; and the instruction encoding module 109 encodes the instruction into an infrared signal. If the earphone detection module 105 detects that the earphone is not plugged into the audio signal outlet 104: the earphone detection module 105 transmits a not in use signal to the first MCU 106; the first MCU 106 transmits an instruction to the instruction encoding module 109 for turning on a volume of the host 20; and the instruction encoding module 109 encodes the instruction into an infrared signal. The transmitter 110 receives the infrared signals from the instruction encoding module 109, and then transmits the infrared signals to the host 20.

The key module 107 is used for providing a plurality of control keys for user operations. The key instruction processing module 108 generates a control instruction according to the operation of the control keys by the user, and transmits the control instruction to the instruction encoding module 109 or the audio signal amplifying module 102 according to the signals from the earphone jack. For example, if there is no signal from the earphone jack, that is, the earphone is not plugged into the audio signal outlet 104: the key instruction processing module 108 transmits a volume control instruction entered by the user to the instruction encoding module 109; the instruction encoding module 109 encodes the control instruction into an infrared signal; and the transmitter 110 transmits the infrared signal to the host 20 to adjust the volume thereof. Otherwise, if there is a signal from the earphone jack, that is, the earphone is plugged into the audio signal outlet 104: the key instruction processing module 108 transmits a volume control instruction entered by the user to the audio signal amplifying module 102; and the audio signal amplifying module 102 adjusts the audio signal according to the control instruction, thus adjusting a volume of the earphone.

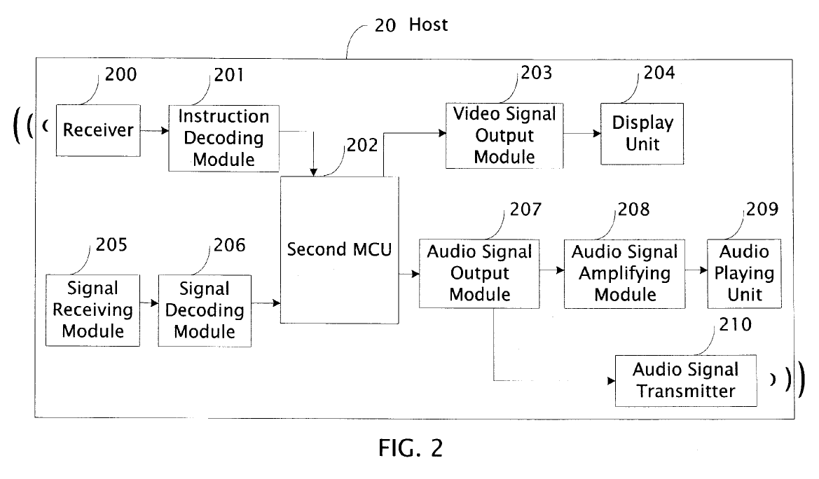

FIG. 2 is a block diagram of hardware infrastructure of the host 20 of the system. The host 20 includes a receiver 200, an instruction decoding module 201, a second MCU 202, a television (TV) signal playing unit, a signal receiving module 205, and a signal decoding module 206. The TV signal playing unit includes a video display unit, a loudspeaker audio playing unit, and an audio signal transmitter 210. The video display unit includes a video signal output module 203 and a display unit 204. The loudspeaker audio playing unit includes an audio signal output module 207, an audio signal amplifying module 208, and an audio playing unit 209. The receiver 200 receives the infrared signals from the remote control 10, and transmits the infrared signals to the instruction decoding module 201. The instruction decoding module 201 decodes the infrared signals into corresponding instructions (i.e., turning off the audio signal, turning on the audio signal, or adjusting a volume of the audio signal). The signal receiving module 205 is for receiving TV signals, and transmits the TV signals to the signal decoding module 206. The signal decoding module 206 decodes the TV signals into video signals and audio signals. The video signal output module 203 outputs the video signals, thereby displaying pictures on the display unit 204. Simultaneously, the audio signal output module 207 outputs the audio signals corresponding to the video signals to the audio playing unit 209 or the audio signal transmitter 210 according to the decoded instruction from the instruction decoding module 201. For example, when the decoded instruction is for turning off the audio signal to the audio playing unit 209, that means the earphone is plugged into the audio signal outlet 104, and the audio signal output module 207 outputs the audio signals to the receiver 101 through the audio signal transmitter 210. When the decoded instruction is for turning on the audio signal or adjusting the volume of the audio signal, that means the earphone is not plugged into the audio signal outlet 104, and the audio signal output module 207 outputs the adjusted audio signals to the audio playing unit 209 through the audio signal amplifying module 208.

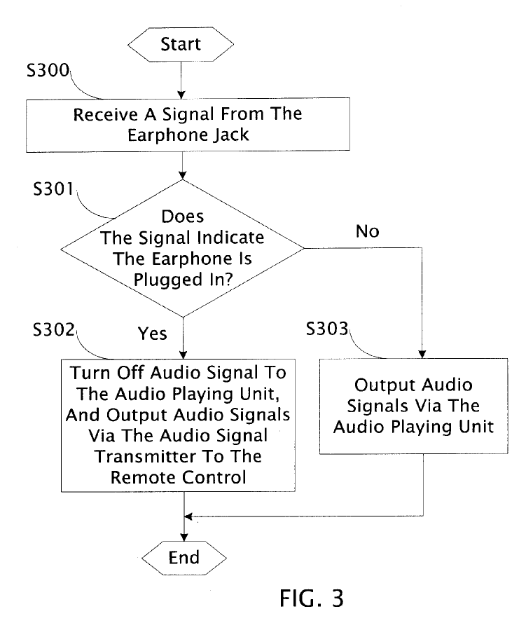

FIG. 3 is a flowchart of a preferred method of remote control performed by utilizing the system. In step S300, the remote control 10 receives a signal from an earphone jack. In step S301, the remote control 10 determines whether the signal indicates that the earphone is plugged in. If the earphone is plugged in, then in step S302, the host 20 turns off the audio signals to the audio playing unit 209, and outputs audio signals via the audio signal transmitter to the remote control 10. If the earphone is not plugged in, then in step S303, the host 20 outputs the audio signals via the audio playing unit 209.

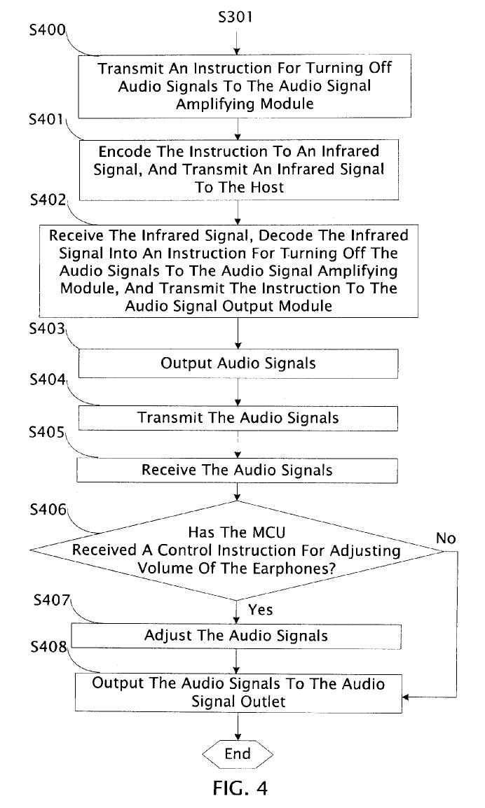

FIG. 4 is a flowchart of implementing step S302 of FIG. 3, namely turning off the audio signals to an audio playing unit 209, and outputting audio signals via the audio signal transmitter 210 to the remote control 10. In step S400, when the signal from the earphone jack indicates that the earphone is plugged into the audio signal outlet 104, the first MCU 106 transmits an instruction for turning off the audio signals to the audio signal amplifying module 208 of the host 20. In step S401, the instruction encoding module 109 encodes the instruction into an infrared signal, and transmits the infrared signal to the receiver 200 through the transmitter 110. In step S402, the instruction decoding module 201 receives the infrared signal from the receiver 200, decodes the infrared signal into an instruction for turning off the audio signals to the audio signal amplifying module 208, and transmits the instruction to the audio signal output module 207. In step S403, the audio signal output module 207 outputs the audio signals from the TV signals to the audio signal transmitter 210 instead of the audio signal amplifying module 208, thereby turning off the audio signal to the audio signal amplifying module 208. In step S404, the audio signal transmitter 210 transmits the audio signals to the remote control 10. In step S405, the receiver 101 receives the audio signals, and transmits the audio signals to the audio signal amplifying module 102. In step S406, the first MCU 106 checks whether it has received a control instruction for adjusting the volume of the earphone from the key instruction processing module 108. That is, if the key module 107 receives a user operation for adjusting the volume of the earphone, the key instruction processing module 108 generates a corresponding control instruction, and transmits the control instruction to the first MCU 106. If the first MCU 106 has not received a control instruction, the procedure goes directly to step S408 described below. The first MCU 106 has received a control instruction, in step S407, the first MCU 106 transmits the control instruction to the audio signal amplifying module 102, and the audio signal amplifying module 102 adjusts the volume of the audio signal to the audio signal outlet 104 according to the control instruction, whereupon the procedure goes to step S408. In step S408, the audio signal output module 103 outputs the audio signals to the audio signal outlet 104. The audio signals are either unadjusted or adjusted, according to whether there has been a user operation for adjusting the volume of the earphone.

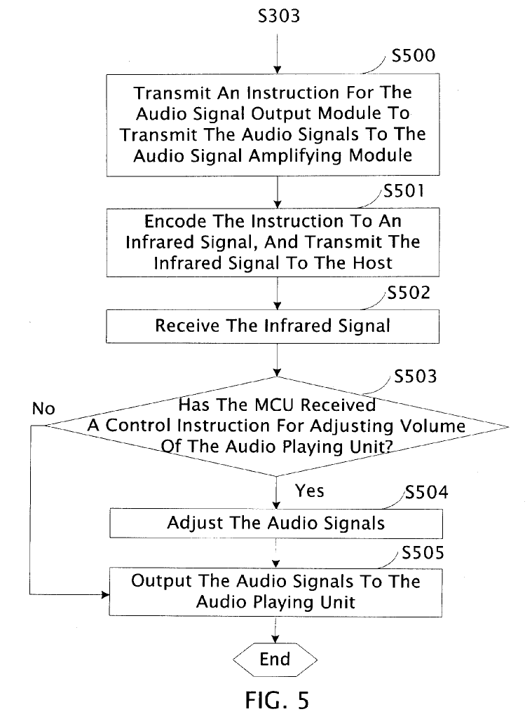

FIG. 5 is a flowchart of implementing step S303 of FIG. 3, namely outputting audio signals via the audio playing unit 209. In step S500, the first MCU 106 transmits an instruction for the audio signal output module 207 to transmit the audio signals to the audio signal amplifying module 208 of the host 20. In step S501, the instruction encoding module 109 encodes the instruction to an infrared signal, and the transmitter 110 transmits the infrared signal to the receiver 200. In step S502, the instruction decoding module 201 receives the infrared signal from the receiver 200, and decodes the infrared signal into an instruction for the audio playing unit 209. In step S503, the first MCU 106 checks whether it has received a control instruction for adjusting volume from the key instruction processing module 108. That is, if the key module 107 receives a user operation for adjusting volume, the key instruction processing module 108 generates a corresponding control instruction, and transmits the control instruction to the first MCU 106. If the first MCU 106 has not received a control instruction, the procedure goes directly to step S505 described below. If the first MCU 106 has received a control instruction, in step S504, the first MCU 106 transmits the control instruction to the host 20, and the audio signal amplifying module 208 adjusts a volume of the audio playing unit 209 according to the control instruction, whereupon the procedure goes to step S505. In step S505, the audio signal output module 207 outputs the audio signals to the audio playing unit 209. The audio signals are either unadjusted or adjusted, according to whether there has been a user operation for adjusting the volume of the audio playing unit 209.

Because a hand held remote control is a common piece of equipment for wirelessly controlling many electronic devices, the above-described system and method provide convenient means for a user to take advantage of the availability of an earphone if desired.

Although the present invention has been specifically described on the basis of preferred embodiments including a preferred method, the invention is not to be construed as being limited thereto. Various changes or modifications may be made to the embodiments including the method without departing from the scope and spirit of the invention.

What is claimed is:

1. A remote control system with a wireless earphone function, the system comprising a host and a remote control, the host comprising an audio signal amplifying module, and an audio playing unit for playing sounds, wherein:
the host further comprises:
an audio signal output module for outputting audio signals;
an audio signal transmitter for transmitting the audio signals to the remote control; and
the remote control comprises:
an earphone audio unit comprising a receiver for receiving the audio signals from the host, an audio signal outlet for connecting with an earphone, and an earphone detection module for detecting whether an earphone is connected with the audio signal outlet;
a first MCU (Microprogrammable Control Unit) for generating a first volume adjusting instruction if the earphone detection module detects that the earphone is connected with the audio signal outlet; and
a transmitter for transmitting a first signal corresponding to the first volume adjusting instruction to the host; and
when the host receives the first signal, the host does not output audio signals to the audio playing unit.

2. The system described in claim 1, wherein the first volume adjusting instruction comprises an instruction for turning off audio signals to the audio signal amplifying module, whereupon the host only transmits the audio signals to the remote control.

3. The system described in claim 1, wherein the first MCU generates a second volume adjusting instruction if the earphone detection module detects that the earphone is not connected with the audio signal outlet, the remote control unit transmits a second signal corresponding to the second volume adjusting instruction to the host, and the host receives the second signal and adjusts the volume of the audio playing unit according to the second signal.

4. The system described in claim 3, wherein the second volume adjusting instruction comprises an instruction for turning on the volume, whereupon the host outputs audio signals to the audio playing unit.

5. The system described in claim 1, wherein the remote control adjusts a volume of audio signals output from the audio signal outlet at any selected time when the earphone detection module detects that the earphone is connected with the audio signal outlet, whereas the remote control adjusts a volume of audio signals output to the audio playing unit at any selected time when the earphone detection module detects that the earphone is not connected with the audio signal outlet.

6. A remote control method with a wireless earphone function, the method utilizing a host for playing video signals and audio signals and a remote control, the host comprising an audio playing unit, the method comprising the steps of:
the remote control receiving a connectivity signal from an audio signal outlet thereof, and determining whether the connectivity signal indicates that an earphone is connected with the audio signal outlet;
the remote control transmitting a first volume adjusting instruction to the host if the signal indicates that an earphone is connected with the audio signal outlet;
the host adjusting a volume of the audio playing unit according to the first volume adjusting instruction;
the host transmitting audio signals to the remote control;
the remote control receiving the audio signals; and
the remote control outputting the audio signals to the earphone via the audio signal outlet.

7. The method described in claim 6, wherein the first volume adjusting instruction comprises an instruction for turning off audio signals to the audio playing unit, whereupon the host only transmits the audio signals to the remote control.

8. The method described in claim 6, further comprising the steps of:
the remote control generating a second volume adjusting instruction if the connectivity signal indicates that the earphone is not connected with the audio signal outlet;
the remote control transmitting a second volume adjusting instruction to the host; and
the host adjusting the volume of the audio playing unit according to the second volume adjusting instruction.

9. The method described in claim 8, wherein the second volume adjusting instruction comprises an instruction for turning on audio signals to the audio playing unit, whereupon the host outputs the audio signals to the audio playing unit.

10. The method described in claim 6, further comprising the steps of:
a user adjusting a volume of audio signals output from the audio signal outlet at any selected time when the remote control detects that the earphone is connected with the audio signal outlet; or
the user adjusting a volume of the audio playing unit via the remote control at any selected time when the remote control detects that the earphone is not connected with the audio signal outlet.
